(19) United States
(12) Patent Application Publication
(10) Pub. No.: US 2016/0037154 A1
(43) Pub. Date: Feb. 4, 2016

(54) IMAGE PROCESSING SYSTEM AND METHOD

(71) Applicant: National Taiwan University, Taipei City (TW)

(72) Inventors: Yi-Ping HUNG, Taipei City (TW); Yen-Ting YEH, Taipei City (TW)

(73) Assignee: NATIONAL TAIWAN UNIVERSITY, Taipei City (TW)

(21) Appl. No.: 14/597,765

(22) Filed: Jan. 15, 2015

(30) Foreign Application Priority Data
Jul. 30, 2014 (TW) 103126088

(51) Int. Cl. H04N 13/02; H04N 5/225; G06T 7/00; G06F 3/01; G06T 15/10

(52) U.S. Cl. CPC H04N 13/0296; H04N 13/0242; G06F 3/013; G06T 15/10; G06T 7/0018; G06T 7/0051; H04N 5/2253

(57) ABSTRACT

The present invention provides an image processing system and method, the image processing system uses at least two cameras, and the location of the cameras can be changed due to the easiness of installation onto a vehicle and number of the cameras around the vehicle. The present invention uses the image analysis method to evaluate the depth of objects around the vehicle, and then generate a 3D model with depth information to reduce the distortion of the image. After that, the image will be displayed on the wide-area electronic rearview mirror to provide the driver a rearview image more correctly.

### CROSS-REFERENCE TO RELATED APPLICATION

This application claims the priority of Taiwanese patent application No. 103126088, filed on Jul. 30, 2014, which is incorporated herewith by reference.

### BACKGROUND OF THE INVENTION

1. Field of the Invention

The present invention generally relates to the multimedia field, and more specifically to an image processing system and method with respect to the technologies of monitoring a rearview mirror image for a vehicle and a multimedia system interface.

2. The Prior Arts

In the traditional way of driving, the driver can check the situation behind the vehicle or pedestrian through the electronic rearview mirror. However, driver cannot know the status of the near vehicle around therein simultaneously due to the vision of the dead corner. Recently, the photographic equipment technology for supporting the vehicle driving has been developing vigorously. However, most of photographic equipments only provide passive image around the vehicle to assist the driver to avoid accidents. The existing wide-area electronic rearview mirror in the market is a fish-eye camera installed onto the rear of the vehicle, and displayed the image on the electronic rearview mirror after the image deformation. Although the driver can see the rear view of the vehicle (behind the bumper) more clearly by installing the fish-eye camera, the driver still needs to notice the left and right sides of the electronic rearview mirror to confirm the left and right rear sides of the vehicle in order to fully control the rear situation of the vehicle without dead corner.

Nowadays, there are some disadvantages in cameras for driving assistant technology. In the conventional comprehensive vehicle monitoring system, such as Around View Monitor of Nissan and Eagle View System of Luxgen, the driver only can obtain the limited information around the vehicle through a top view, but cannot obtain the information of the real three-dimensional (3D) view around the vehicle, while the driver has to switch the visual angle between the multiple electronic rearview mirrors to see all information of the vehicle and pedestrian behind the vehicle. In the dead corner of the driver vision, although the driver can see the view around the vehicle through cameras installed around the vehicle, the driver still cannot fully know the information near the vehicle, hence, the visual angle of driver is still limited to a top view and the visual range is restricted.

Further, the Fujitsu Company has a driving photography assistant system which uses a fixed 3D projective model technology, wherein there is no change even in view of the depth of front sights of objects around the vehicle and, hence, it is unable to provide the information of the instant 3D image of front sights around the vehicle to the driver. Therefore, in order to assist the driver so as to protect the road safety, it is necessary to provide a wide-area electronic rearview mirror monitoring frame with the image generated from a multi cameras, which enable the driver to fast do the reaction for danger event, thereby to reach the purpose of driving safety.

It is therefore desirable to provide an image processing system for an electronic rearview mirror. The said electronic rearview mirror can evaluate the depth of front sights of objects around the vehicle, and then change a 3D projective model with depth information. After that, the image with depth information will be displayed on the electronic rearview mirror to provide the driver a rear view image more correctly in order to achieve the purpose of driving safety.

### SUMMARY OF THE INVENTION

In light of the foregoing drawbacks, an objective of the present invention is to provide a small-size low-power transceiver that is suitable for a portable device.

For achieving the foregoing objective, the present invention provides an image processing system and method thereof for an electronic rearview mirror. The image processing system of the present invention may include real images, photographed by at least two cameras; a depth value estimation module, having at least a depth value estimation unit; a 3D geometric model generating module; a image processing module; a virtual camera; a visual angle detecting module and a display module.

The image processing system of the present invention uses at least two cameras, and the location of the cameras can be changed due to the easiness of installation onto a vehicle or number of the cameras. At least two cameras may receive an image behind the vehicle and images on a rear side of the vehicle. The depth value estimation unit in the depth value estimation module may use the image behind the vehicle and the image on the rear side of the vehicle taken by the at least two cameras to evaluate the depth value of visual sights around the vehicle, and further transfer the information of depth value to the 3D geometric model generating module to avoid the image synthesized by the image processing module having the ghosting and high distortion. The 3D geometric model generating module may use the information of depth value to generate a 3D geometric model having the information of depth value of objects around the vehicle.

The image processing module may synthesize the 3D geometric model having the information of depth value of objects around the vehicle with the image behind the vehicle and the image on the rear side of the vehicle, thereby reduce the distortion of the image and provide the image of rear view more correctly.

The virtual camera connected to the image processing module may decide the display mode of the image synthesized by the image processing module.

The display module may display an image synthesized by the image processing module and the display mode decided by the virtual camera.

Moreover, the virtual camera may generate the different electronic rearview mirror image by placing position of the virtual camera, for example, the driver may see the relative relationship between its vehicle and the near vehicle behind thereof or the relative relationship between its vehicle and the pedestrian information in the wide-area electronic rearview mirror so as to place the virtual camera onto a top position before the vehicle. On the other side, the driver may see the image through an visual angle same as the conventional rearview minor without being blocked by the vehicle's self-image by placing the virtual camera behind the conventional rearview mirror of the vehicle.

The visual angle detecting module connected to the display module may get the sight direction of driver from detecting an angle between the electronic rearview minor and eyes position of the driver and further change display contents displayed by the display module according to the sight direction.

Moreover, the depth value estimation module further comprises at least a depth value estimation unit to evaluate the depth value around the vehicle by using the image behind the vehicle and the image on the rear side of the vehicle.

Preferably, the 3D geometric model generating module may decrease the distortion of the image to provide the rearview image more properly.

Preferably, when the virtual camera is placed on the conventional place of the rearview mirror, the driver may see the rearview image without being blocked by the vehicle itself; when the virtual camera is placed on a top of front of the vehicle, the driver may see the vehicle itself and other objects behind the vehicle, such as near vehicle behind the vehicle or the information of the pedestrian.

Preferably, the image processing system may be installed in the electronic rearview mirror or in the vehicle

Preferably, the visual angle detecting module may use the information about the sight direction of the driver to display an appropriate image on the display module to simulate a real 3D scene and a real optical effect to improve the reality and third dominion of the display module.

The embodiment of the present invention also provides an image processing method for evaluating a depth value of objects around a vehicle and changing a 3D geometric model to generate a rearview image according to the 3D geometric model having the depth value, comprising: an image receiving step, which corrects the extrinsic parameters of cameras around the vehicle to let images obtained from the cameras be executed in other steps; a depth value estimation step, wherein a depth value estimation module evaluates the depth value around the vehicle from images photographed by the cameras and then transfers the depth value information to a 3D geometric model generating module to avoid the image synthesized by a image processing module having the ghosting and high distortion; a 3D geometric model generating step, wherein the 3D geometric model generating module generates the 3D geometric model having the depth information; an image synthesizing step, wherein a image processing module synthesizes the images photographed by the cameras around the vehicle and the 3D geometric model having the depth information; a displaying step, a display module may display an image synthesized by the image processing module and a display mode decided by a virtual camera; and a visual angle detecting step, wherein a visual angle detecting module gets a sight direction of a driver from a detecting an angle between an electronic rearview mirror and eyes position of the driver, and further changes display contents displayed by the display module according to the sight direction.

### BRIEF DESCRIPTION OF THE DRAWINGS

The present invention will be apparent to those skilled in the art by reading the following detailed description of preferred exemplary embodiments thereof, with reference to the attached drawings, in which:

FIG. 1 is a block diagram illustrating an image processing system of the present invention;

FIG. 2 is a flowchart illustrating an image processing method of the present invention;

FIG. 3 is a schematic diagram illustrating the location of cameras of the present invention;

FIG. 4 is a schematic diagram illustrating the real image around the vehicle in accordance with an exemplary embodiment of the present invention;

FIG. 5a is a schematic diagram illustrating the response relationship of Homography;

FIG. 5b is a schematic diagram illustrating the matrix of Homography;

FIG. 6 is a schematic diagram illustrating on how to find the depth of objects in the environment (the distance from the camera) through algorithm of Stereo;

FIG. 7 is a schematic diagram illustrating the normal 3D geometric model and the 3D geometric model with the depth information;

FIG. 8a is a schematic diagram illustrating the relationship of the position between the virtual camera and the vehicle in accordance with an exemplary embodiment of the present invention;

FIG. 8b is a schematic diagram illustrating the relationship of the position between the virtual camera and the vehicle in accordance with the other exemplary embodiment of the present invention;

FIG. 9a is a schematic diagram illustrating the real 3D image around the vehicle seen by the electronic rearview mirror in accordance with an exemplary embodiment of the present invention;

FIG. 9b is a schematic diagram illustrating the real 3D image around the vehicle seen by the electronic rearview mirror in accordance with the other exemplary embodiment of the present invention;

FIG. 10a is a schematic diagram illustrating the electronic rearview mirror display image obtained from the angle between the first position of eyes of the driver and the electronic rearview mirror; and

FIG. 10b is a schematic diagram illustrating the electronic rearview mirror display image obtained from the angle between the second position of eyes of the driver and the electronic rearview mirror.

### DETAILED DESCRIPTION OF THE PREFERRED EMBODIMENT

The accompanying drawings are included to provide a further understanding of the invention, and are incorporated in and constitute a part of this specification. The drawings illustrate exemplary embodiments of the invention and, together with the description, serve to explain the principles of the invention.

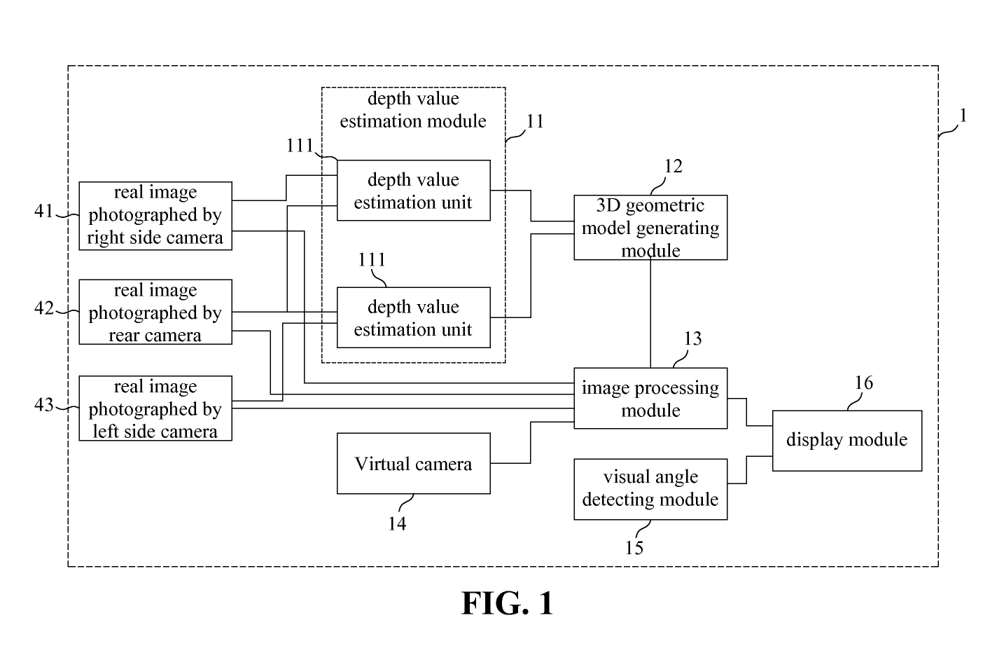

With regard to FIGS. 1-10b, the drawings showing exemplary embodiments are semi-diagrammatic and not to scale and, particularly, some of the dimensions are for clarity of presentation and are shown exaggerated in the drawings. Similarly, although the views in the drawings for ease of description generally show similar orientations, this depiction in the drawings is arbitrary for the most part. Generally, the present invention can be operated in any orientation.

In light of the foregoing drawings, an objective of the present invention is to provide an image processing system. Referring to FIG. 1, FIG. 1 is a block diagram illustrating an image processing system of the present invention. Referring to FIG. 1, the image processing system 1 of the present invention may include real images 41, 42 and 43 photographed by cameras installed around the vehicle; a depth value estimation module 11, having at least a depth value estimation unit 111; a 3D geometric model generating module 12; an image processing module 13; a virtual camera 14; an visual angle detecting module 15, and a display module 16.

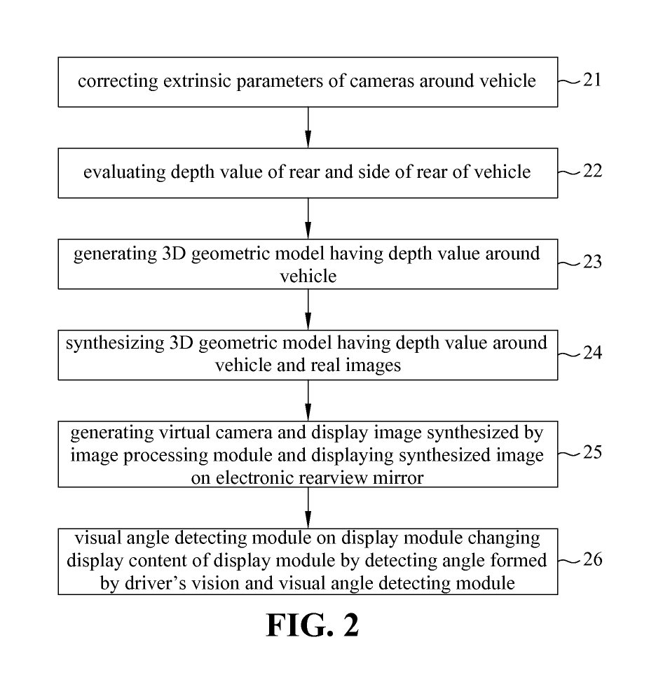

Referring to FIG. 2, FIG. 2 is a flowchart illustrating an image processing method of the present invention. Referring to FIG. 1 and FIG. 2, the image processing step includes an image receiving step 21, a depth value estimation step 22, a 3D geometric model generating step 23, an image synthesizing step 24, a displaying step 25, and a visual angle detecting step 26.

In the image receiving step 21, the image processing system 1 may correct the extrinsic parameters of cameras around the vehicle and transfer the real images 41, 42 and 43 to the depth value estimation module 11 to evaluate the depth value by the depth value estimation unit 111 when the image processing system 1 receives the real images 41, 42 and 43 photographed by the cameras around the vehicle. On the other hand, the image processing system 1 may transfer the real images 41, 42 and 43 to the image processing module 13 at the same time.

In the depth value estimation step 22, the depth value estimation unit 111 of the depth value estimation module 11 may transfer a depth value estimation information to the 3D geometric model generating module 12 after the depth value estimation unit 111 of the depth value estimation module 11 evaluating the depth value of the rear and side of rear of the vehicle.

In the 3D geometric model generating step 23, the 3D geometric model generating module 12 may generate a 3D geometric model (not shown in figure) having the depth value around the vehicle according to the depth value estimation information after the 3D geometric model generating module 12 receiving the depth value estimation information around the vehicle. After that, the 3D geometric model generating module 12 transfers the 3D geometric model having the depth value around the vehicle to the image processing module 13.

In the image synthesizing step 24, the image processing module 13 may synthesize the 3D geometric model having the depth value around the vehicle and the real images 41, 42 and 43 to generate the real 3D image having the depth value around the vehicle. At the same time, the image processing system 1 can generate the virtual camera 14 connected to the image processing module 13 to decide the display mode of the real 3D image having the depth value around the vehicle.

In the displaying step 25, the display module 16 may display an image synthesized by the image processing module 13 and display the synthesized image on the electronic rearview mirror according to the display mode decided by the position of the virtual camera 14.

In the vision angle detecting step 26, the visual angle detecting module 15 on the display module 16 can change the display content of the display module 16 by detecting the angle formed by driver's vision and the visual angle detecting module 15.

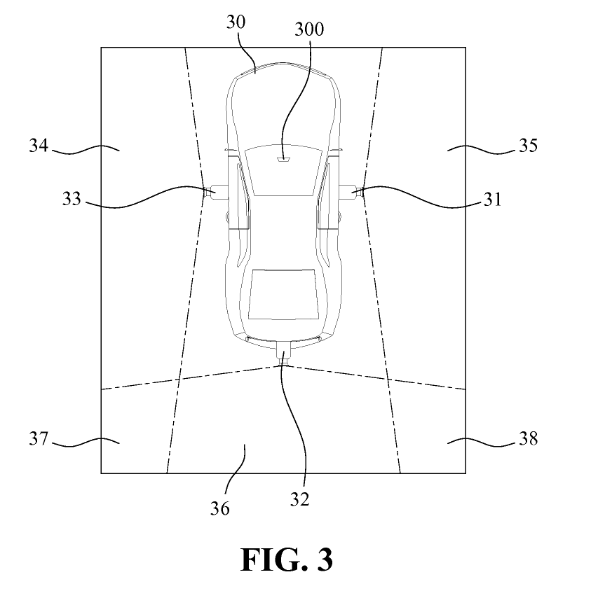

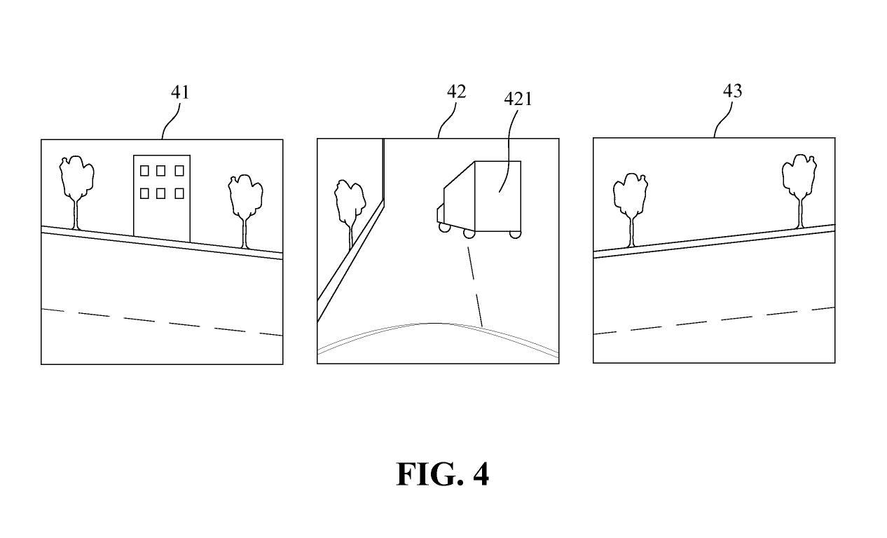

Each step of the present invention will now be described in detail. Referring to FIG. 3, FIG. 3 is a schematic diagram illustrating the position of cameras of the present invention. Referring to FIG. 3, the image processing system 1 is installed in the electronic rearview mirror 300. The cameras 31, 32, and 33 are set up in the right side, rear side and left side of the vehicle 30. The areas 34, 35, and 36 are the areas photographed by a single camera. The areas 37 and 38 are the areas photographed by the two cameras close to each other. Referring to FIG. 4, FIG. 4 is a schematic diagram illustrating the real image around the vehicle in accordance with an exemplary embodiment of the present invention. Referring to FIG. 4, the real images 41, 42 and 43 around the vehicle 30 are photographed by the cameras 31, 32, and 33. There is another vehicle 421 in the real image 42. In this embodiment of the present invention, the image processing system 1 may use the three cameras 41, 42, and 43 to photograph the real images 41, 42 and 43. In other embodiment of the present invention, the image processing system 1 may use the two cameras which are in the left rear and right rear of the vehicle 30 to photograph the real images.

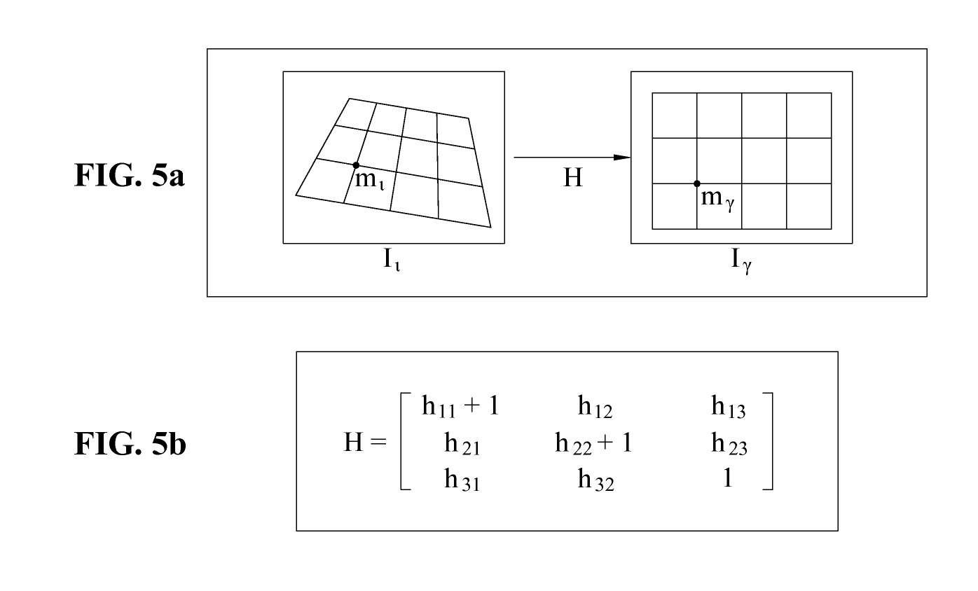

In the image receiving step 21, to synthesize the real images 41, 42, and 43 photographed by the cameras 31, 32, and 33 to one rearview image, the image processing system 1 have to know the relative position and angles between the cameras 31, 32, and 33 and the vehicle 30. Therefore, the extrinsic parameters of the cameras 31, 32, and 33 have to be corrected. Referring to FIG. 5a, FIG. 5a is a schematic diagram illustrating the response relationship of Homography. The vehicle 30 is driven in the environment wherein there are a lot of feature points (not shown in figure) to capture the images photographed by the cameras 31, 32 and 33. Referring to FIG. 5a, wherein the m_{y}=Hmₗ, the w_{y} is the feature coordinate point of the ground plane and mₗ is the feature coordinate point of the photographed images. Referring to FIG. 5b, FIG. 5b is a schematic diagram illustrating the matrix of Homography. Referring to FIG. 5b, the present invention may not only use the corresponding spatial coordinates of the feature points and the photographed images but also the minimize formula m_{y}−Hmₗ to get the optimal solution of the matrix H (Homography). After getting the optimal solution of the matrix H to correct the cameras 31, 32, and 33, the image processing system 1 may obtain not only the positions of cameras 31, 32, and 33 in the vehicle 30 but also the extrinsic parameters of the cameras 31, 32, and 33.

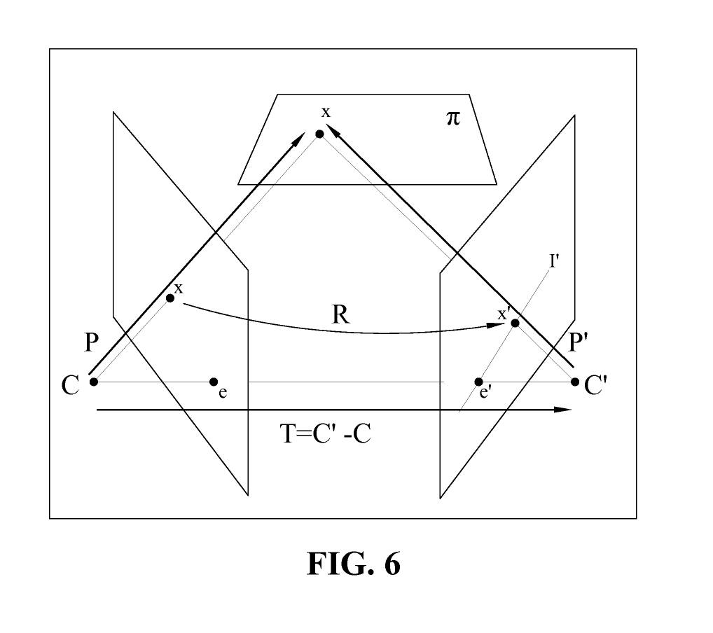

After finishing the image receiving step 21, the image processing system 1 will enter into the depth value estimation step 22. The depth value estimation unit 111 of the depth value estimation module 11 may evaluate the depth value around the vehicle 30 through the real images (real images 41 and 42 or real images 42 and 43) of the near cameras (the camera 31 and 32 or the camera 32 and 33) after the cameras 31, 32, and 33 photographing the real images 41, 42, and 43. The image synthesized by the image processing module 13 will have a situation of ghosting and high distortion if the image processing system 1 does not know the depth value of objects around the vehicle 30. Therefore, the image processing system 1 needs the depth value estimation module 11 to evaluate the depth value. Referring to FIG. 6, FIG. 6 is a schematic diagram illustrating how to find the depth of objects in the environment (the distance from the camera) through algorithm of Stereo. Referring to FIG. 6, the image processing system 1 may use the depth value estimation unit 111 of the depth value estimation module 11 to evaluate the depth value. The depth value estimation unit 111 may use the images photographed by the near cameras to do the Stereo algorithm. Stereo is to find the same feature points (x, x′) in the two images (p, p′) photographed by the two cameras (C, C′) and using not only the relative position (extrinsic parameters of cameras) of the two cameras (C, C′) but also the respective positions of two feature points in an image to evaluate the position of x (the x can be another vehicle 421 in this embodiment) in the real world. That way, the image processing system 1 can know the distance between x and two near cameras. Referring back to FIG. 1, wherein the cameras (C, C′) can be the cameras (31, 32) or the cameras (32, 33), and wherein the two images (p, p′) can be the real images (41, 42) or the real images (42, 43). After confirming the position and the angle of the cameras (31, 32) and the cameras (32, 33), the distance between object x and the cameras 31, 32, and 33 and the position of object x in the real images 41, 42 and 43 have the regular relationship. Therefore, the image processing system 1 may locate the position of another vehicle 421 in real images through image analysis in this embodiment of the present invention. Furthermore, the image processing system 1 may obtain the distance between another vehicle 421 and the cameras 31, 32, and 33 using the aforementioned relationship.

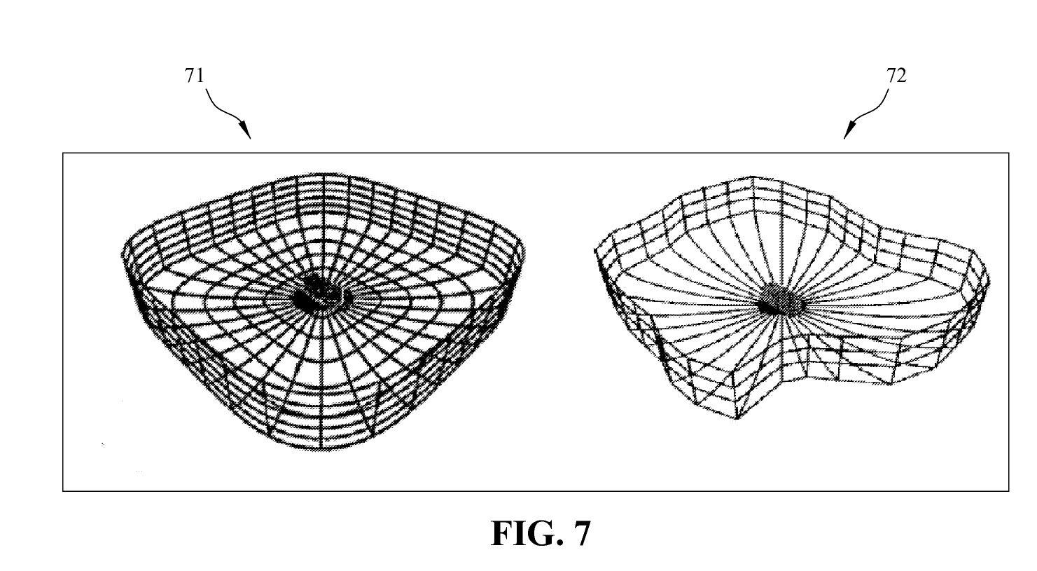

After finishing the depth value estimation step 22, the image processing system 1 will enter into the 3D geometric model generating step 23. Referring to FIG. 7, FIG. 7 is a schematic diagram illustrating the normal 3D geometric model and the 3D geometric model with the depth information. Referring to FIG. 1 and FIG. 7, the depth value estimation module 11 may transfer the depth value estimation information to the 3D geometric model generating module 12 after evaluating the depth value through the depth value estimation unit 111. After that, the 3D geometric model generating module 12 may generate a 3D geometric model 72 having the depth information. The 3D geometric model 71 is a conventional 3D geometric model. The 3D geometric model 72 is the 3D geometric model changed from the generation based on the difference of the depth information around the vehicle 30 when another vehicle has been detected by the image processing system 1 in the left rear side of the vehicle 30 (the left-up corner is the front of the vehicle 30).

After finishing the three-dimensional geometric model generating step 23, the image processing system 1 will enter into the image synthesizing step 24. The real images 41, 42, and 43 and the 3D geometric model 72 may be transferred to the image processing module 13 to do the image synthesizing. The method of image synthesizing can be the 2D image lookup table method in this embodiment. The 2D image lookup table method can obtain the correspondence table (not shown in figure) between the real images 41, 42, 43 and the electronic rearview mirror 300 through the relative relationship between the real images 41, 42, 43 and the 3D geometric model 72 and the relative relationship between the 3D geometric model 72 and the rearview minor 300. The synthesizing method can be three-dimensional texture method in other embodiment so as to synthesize the real images 41, 42 and 43. In other embodiment, The image processing module 13 may synthesize the real images 41, 42 and 43 through a 3D texture image method, the method is to project the real images 41, 42 and 43 into the 3D geometric model 72, respectively, so as to obtain one 3D geometric model 72 combined with the depth information of the real images 41, 42, and 43.

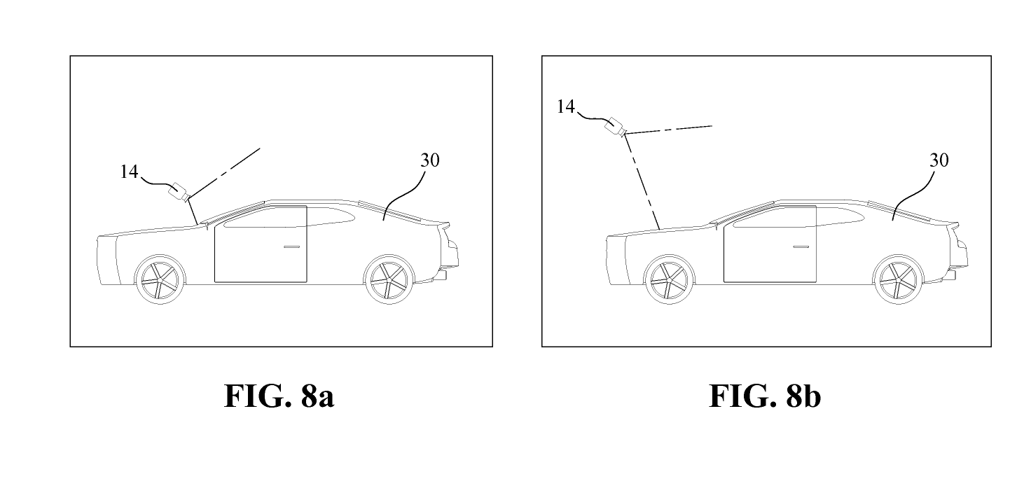

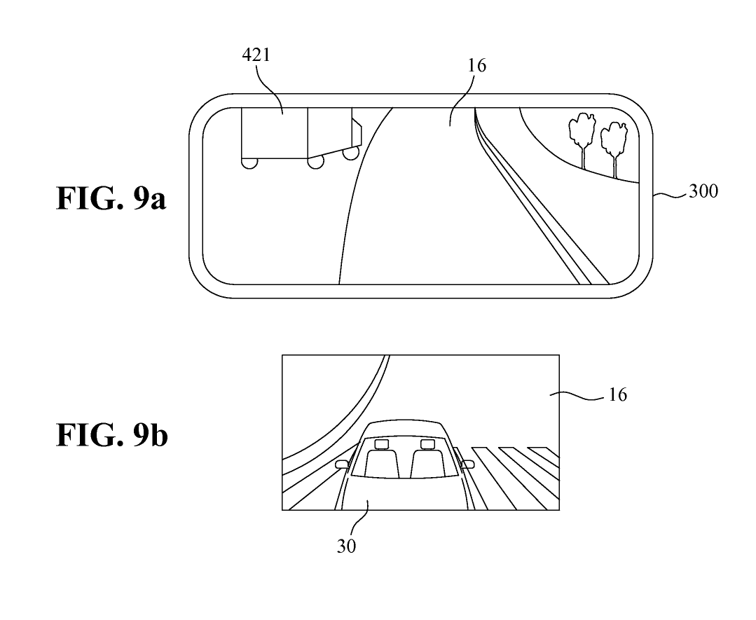

After finishing the image synthesizing step 24, the image processing system 1 will enter into the displaying step 25. Referring to FIGS. 8a and 8b, FIG. 8a is a schematic diagram illustrating the relationship of the position between the virtual camera and the vehicle in accordance with an exemplary embodiment of the present invention. FIG. 8b is a schematic diagram illustrating the relationship of the position between the virtual camera and the vehicle in accordance with the other exemplary embodiment of the present invention. Referring to FIGS. 9a and 9b, FIG. 9a is a schematic diagram illustrating the real three-dimensional image around the vehicle seen by the electronic rearview mirror in accordance with an exemplary embodiment of the present invention. FIG. 9b is a schematic diagram illustrating the real three-dimensional image around the vehicle seen by the electronic rearview mirror in accordance with the other exemplary embodiment of the present invention. Referring to FIG. 1, FIG. 8a, FIG. 8b, FIG. 9a, and FIG. 9b at the same time, the image processing system 1 can generate the virtual camera 14 connected to the image processing module 13. The virtual camera 14 can decide a display mode of the image synthesized in the image synthesizing step 24. In other words, the rearview image displayed on the display module 16 can be generated due to the difference of the position of the virtual camera 14. The image processing system 1 may place the virtual camera 14 on the conventional place of the rearview mirror in this embodiment of the present invention as shown in FIG. 8a. The driver may see the real 3D image from the display module 16 of the electronic rearview mirror 300 as shown in FIG. 9a without being blocked by the vehicle 30 itself. Referring to FIG. 9a, apparently, there is another vehicle 421 on the left rear side of vehicle 30 on the display module 16 of the electronic rearview mirror 300. The image processing system 1 may place the virtual camera 14 on the top of front of the vehicle 30 in other embodiment of the present invention as shown in FIG. 8b. The driver may see the real 3D image from the display module 16 of the electronic rearview mirror 300 as shown in FIG. 9b. Referring to FIG. 9b, the driver may see the vehicle 30 and other objects behind the vehicle 30 (like other vehicle behind the vehicle 30 or the information of the pedestrian) on the display module 16 of the electronic rearview mirror 300.

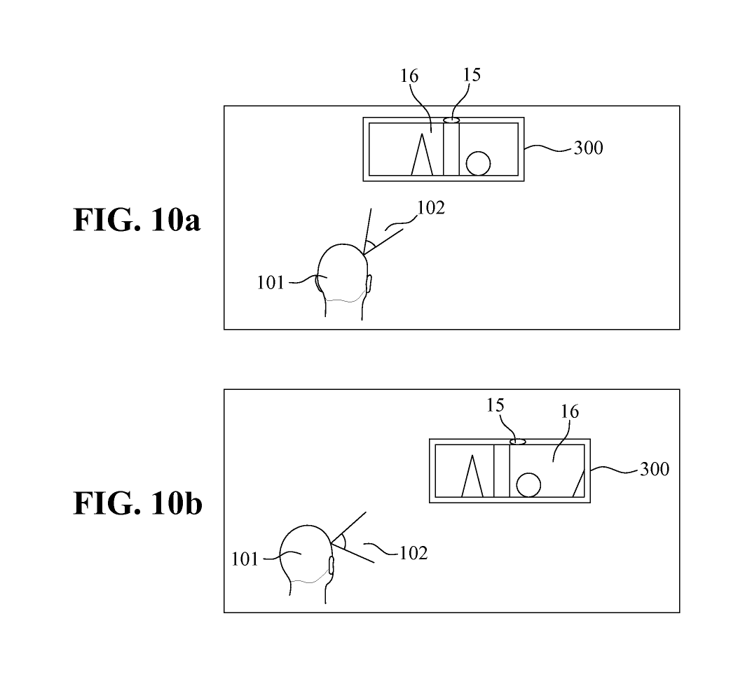

At last, the image processing system 1 will enter into the visual angle detecting step 26. Referring to FIGS. 10a and 10b, FIG. 10a is a schematic diagram illustrating the electronic rearview mirror display image obtained from the angle between the first position of eyes of the driver and the electronic rearview mirror. FIG. 10b is a schematic diagram illustrating the electronic rearview mirror display image obtained from the angle between the second position of eyes of the driver and the electronic rearview mirror. Referring to FIG. 1, FIG. 10a and FIG. 10b at the same time, the visual detecting module 15 installed in the image processing system 1 of the electronic rearview mirror 300 may get the sight direction 102 of the driver 101 from detecting the angle between the electronic rearview mirror 300 and the eyes position of the driver. The image processing system 1 of present invention may use the information about the sight direction 102 of the driver 101 to display an appropriate image on the display module 16 to simulate a real 3D scene and an optical effect to improve the reality and third dimension of the display module 16 inside the electronic rearview mirror 300.

As for the location of the electronic rearview mirror 300, it may be placed in the position of the traditional rearview mirror in this embodiment. The image processing system 1 is installed in the electronic rearview mirror 300 if the electronic rearview mirror 300 is placed in the position of the traditional rearview mirror. The electronic rearview mirror 300 can locate on the dashboard (not shown in figure) in other embodiment. The electronic rearview mirror 300 can use the technology of floating projection to project the rearview image on the windshield (not shown in figure) of the vehicle 30 in other embodiment. The image processing system 1 is installed on the vehicle 30 if the electronic rearview mirror 300 is placed on the dashboard or on the windshield.

The above exemplary embodiments describe the principle and effect of the present invention, but are not limited to the present invention. It will be apparent to those skilled in the art that various modifications and variations can be made to the disclosed embodiments. It is intended that the specification and examples be considered as exemplary only, with a true scope of the disclosure being indicated by the following claims and their equivalents.

Although the present invention has been described with reference to the preferred exemplary embodiments thereof, it is apparent to those skilled in the art that a variety of modifications and changes may be made without departing from the scope of the present invention which is intended to be defined by the appended claims.

What is claimed is:

1. An image processing system, comprising:
a depth value estimation module, which uses an image behind a vehicle and an image on a rear side of the vehicle to evaluate a depth value around the vehicle, and further transfers the information of the depth value to a three-dimensional (3D) geometric model generating module to avoid the images synthesized by a image processing module having the ghosting and high distortion;
a three-dimensional geometric model generating module, which uses the information of the depth value to generate a 3D geometric model having the information of the depth value of objects around the vehicle;
an image processing module, which synthesizes the 3D geometric model having the information of the depth value of objects around the vehicle with the image behind the vehicle and the image on the rear side of the vehicle;
a virtual camera, connected to the image processing module, which decides a display mode of the image synthesized by the image processing module;
a display module, which displays an image synthesized by the image processing module and the display mode decided by the virtual camera; and
a vision angle detecting module, connected to the display module, which gets a sight direction of a driver from detecting an angle between an electronic rearview mirror and eyes position of the driver, and further changes a display content displayed by the display module according to the sight direction.

2. The image processing system according to claim 1, wherein the depth value estimation module further comprising at least a depth value estimation unit to evaluate the depth value around the vehicle by using the image behind the vehicle and the image on the rear side of the vehicle.

3. The image processing system according to claim 1, wherein the 3D geometric model generating module decreases the distortion of the image to provide a rearview image more properly.

4. The image processing system according to claim 1, wherein when the virtual camera is located on the conventional place of the rearview mirror, the driver may see the rearview image without being blocked by the vehicle itself; when the virtual camera is located on a top of front of the vehicle, the driver may see the vehicle itself and other objects behind the vehicle, such as near vehicle behind the vehicle or the information of the pedestrian.

5. The image processing system according to claim 1, the image processing system is installed in the electronic rearview mirror or in the vehicle.

6. The image processing system according to claim 1, wherein the visual angle detecting module uses the information about the sight direction of the driver to display an appropriate image on the display module to simulate a real 3D scene and an optical effect to improve the realistic and third dimension of the image of the display module.

7. An image processing system for an electronic rearview mirror, comprising:
images behind a vehicle and on a rear side of a vehicle photographed by at least two cameras installed onto the vehicle;
a depth value estimation module, which uses the images behind the vehicle and on the rear side of the vehicle to evaluate a depth value around the vehicle, and further transfers the information of the depth value to a 3D geometric model generating module to avoid the images synthesized by an image processing module having the ghosting and high distortion;
a 3D geometric model generating module, which uses the information of the depth value to generate a 3D geometric model having the information of the depth value of objects around the vehicle;
an image processing module, which synthesizes the 3D geometric model having the information of the depth value of objects around the vehicle with the images behind the vehicle and on a rear side of the vehicle;
a virtual camera, connected to the image processing module, which decides a display mode of the images synthesized by the image processing module;
a display module, which displays the images synthesized by the image processing module and the display mode decided by the virtual camera; and
a visual angle detecting module, connected to the display module, which gets a sight direction of a driver from detecting an angle between an electronic rearview mirror and eyes position of the driver, and further changes display contents displayed by the display module according to the sight direction.

8. The image processing system according to claim 7, wherein the depth value estimation module further comprising at least a depth value estimation unit to evaluate the depth value around the vehicle by using the images behind the vehicle and on the rear side of the vehicle.

9. The image processing system according to claim 7, wherein when the number of camera is two, the cameras are installed onto a left rear and a right rear of the vehicle; when the number of camera is three, the cameras are installed onto the left side, right side and a rear of the vehicle or a left rearview mirror, a right rearview mirror and the rear of the vehicle.

10. The image processing system according to claim 7, wherein the 3D geometric model generating module decreases the distortion of the image to provide a rearview image more properly.

11. The image processing system according to claim 7, wherein when the virtual camera is located on the conventional place of the rearview mirror, the driver may see the rearview image without being blocked by the vehicle itself; when the virtual camera is located on a top of front of the vehicle, the driver may see the relative relationship of the vehicle itself and other objects behind the vehicle, such as near vehicle behind the vehicle or the information of the pedestrian.

12. The image processing system according to claim 7, wherein the image processing system is installed in the electronic rearview mirror or in the vehicle.

13. The image processing system according to claim 7, wherein the visual angle detecting module uses the information about a sight direction of a driver to display an appropriate image on the display module to simulate a real 3D scene and an optical effect to improve the reality and third dimension of the display module.

14. A image processing method for evaluating a depth value of objects around a vehicle and changing a 3D geometric model to generate a rearview image according to the three-dimensional geometric model having the depth value, comprising:
an image receiving step, corrects the extrinsic parameters of cameras around the vehicle to let the images obtained from cameras executed in other steps;
a depth value estimation step, wherein a depth value estimation module evaluates the depth value around the vehicle form images photographed by the cameras and then transfers the depth value information to a 3D geometric model generating module to avoid the images synthesized by a image processing module having the ghosting and high distortion;
a three-dimensional geometric model generating step, wherein the three-dimensional geometric model generating module generates the 3D geometric model having the depth information;
an image synthesizing step, wherein the image processing module synthesizes the images photographed by the cameras around the vehicle and the 3D geometric model having the depth information;
a displaying step, wherein a display module displays the images synthesized by the image processing module and a display mode decided by a virtual camera; and
a vision angle detecting step, wherein a visual angle detecting module gets a sight direction of a driver from detecting an angle between an electronic rearview minor and eyes position of the driver, and further changes display contents displayed by the display module according to the sight direction.

15. The image processing method according to claim 14, wherein when the number of camera is two, the cameras are installed onto a left rear and a right rear of the vehicle; when the number of camera is three, the cameras are installed onto the left side, right side and a rear of the vehicle or a left rearview minor, a right rearview minor and the rear of the vehicle.

16. The image processing method according to claim 14, wherein when the virtual camera is located on the conventional place of a rearview mirror, the driver may see a rearview image without being blocked by the vehicle itself; when the virtual camera is located on a top of front of the vehicle, the driver may see the relative relationship of the vehicle itself and other objects behind the vehicle, such as near vehicle behind the vehicle or the information of the pedestrian.
